(19) United States
(12) Patent Application Publication
(10) Pub. No.: US 2022/0391320 A1
(43) Pub. Date: Dec. 8, 2022

(54) OPERATION DEVICE OF CONVOLUTIONAL NEURAL NETWORK, OPERATION METHOD OF CONVOLUTIONAL NEURAL NETWORK AND COMPUTER PROGRAM STORED IN A RECORDING MEDIUM TO EXECUTE THE METHOD THEREOF

(71) Applicant: INDUSTRY-ACADEMIC COOPERATION FOUNDATION, YONSEI UNIVERSITY, Seoul (KR)

(72) Inventors: William Jinho SONG, Seoul (KR); Won Woo RO, Seoul (KR); Hyeonjin KIM, Seoul (KR); Sungwoo AHN, Seoul (KR); Yunho OH, Seoul (KR); Bogil KIM, Seoul (KR)

(73) Assignee: INDUSTRY-ACADEMIC COOPERATION FOUNDATION, YONSEI UNIVERSITY, Seoul (KR)

(21) Appl. No.: 17/752,235

(22) Filed: May 24, 2022

(30) Foreign Application Priority Data
May 24, 2021 (KR) 10-2021-0066176
May 23, 2022 (KR) 10-2022-0063051

(51) Int. Cl. G06F 12/02; G06F 17/16

(52) U.S. Cl. CPC G06F 12/0292; G06F 17/16

(57) ABSTRACT

A convolutional operation method of generating a feature data matrix corresponding to an output data matrix by performing a general matrix multiplication (GEMM) operation on an input data matrix with a set filter matrix includes updating, by at least one processor, a register mapping table so that first destination register addresses of redundant components indicating data redundant with each other among a plurality of components of the input data matrix correspond to a same second destination register address, and performing, by the at least one processor, a convolutional operation by reusing a register having the same second destination register address with respect to the redundant components, based on the register mapping table.

### CROSS-REFERENCE TO RELATED APPLICATION

This application is based on and claims priority under 35 U.S.C. § 119 to Korean Patent Application No. 10-2021-0066176, filed on May 24, 2021, and Korean Patent Application No. 10-2022-0063051 filed on May 23, 2022, in the Korean Intellectual Property Office, the disclosures of which is incorporated by reference herein in their entireties.

### BACKGROUND

### 1. Field

One or more embodiments relate to a convolutional operation device and a convolutional operation method capable of improving memory efficiency by removing unnecessary memory access to redundant data generated during a convolutional operation of an artificial neural network and reusing redundant data stored in a register file.

### 2. Description of the Related Art

A convolutional operation is one of the core operations of deep artificial neural networks and widely used in many computer fields, such as object detection, semantic segmentation, image generation, etc. This convolutional operation is a computation method that may be widely used in artificial intelligence, such as autonomous driving, virtual reality (VR)/augment reality (AR), etc. and applications.

Due to the large amount of data and computational amount of the deep artificial neural network, general-purpose graphics processing units are used as acceleration hardware. The convolutional operation has a large amount of computations that occupies most of the total processing time of the deep artificial neural network.

On the other hand, in a matrix operation process included in a convolutional operation process, since a large amount of data is copied and used in a workspace, there is a problem that the memory usage and the number of access times increase, which are likely to slow down an operation speed and lower energy efficiency.

### SUMMARY

One or more embodiments include a convolutional operation method that has a faster operation speed and a better energy efficiency than a general convolutional operation method since an element ID is given to each component of an input data matrix, and one register may be allocated to redundant components, which are redundant with each other, based on the element ID.

Additional aspects will be set forth in part in the description which follows and, in part, will be apparent from the description, or may be learned by practice of the presented embodiments of the disclosure.

According to one or more embodiments, a convolutional operation method of generating a feature data matrix corresponding to an output data matrix by performing a general matrix multiplication (GEMM) operation on an input data matrix with a set filter matrix includes updating, by at least one processor, a register mapping table so that first destination register addresses of redundant components indicating data redundant with each other among a plurality of components of the input data matrix correspond to a same second destination register address, and performing, by the at least one processor, a convolutional operation by reusing a register having the same second destination register address with respect to the redundant components, based on the register mapping table.

The updating of the register mapping table may include generating an identifier of the plurality of components, and updating the register mapping table so that first destination register addresses of components for which a same identifier is generated among the plurality of components correspond to a same second destination register address.

The identifier may include an element ID, the generating of the identifier may include generating a patch ID of the plurality of components based on an array index of the plurality of components, a number of rows and columns of the filter matrix, and a number of columns of the output data matrix, and generating an element ID of the plurality of components, based on the patch ID and an offset of the plurality of components, and wherein the offset is a value determined based on the patch ID, the number of columns and a number of channels of the input data matrix, and the array index may be a value indicating a location of each component when the plurality of components are arranged in a single-dimensional array.

The identifier may further include a batch ID, the generating of the identifier may further include generating the batch ID of the plurality of components based on the array index of the plurality of components, the number of rows and the number of columns of the filter matrix, and a number of rows and the number of columns of the output data matrix.

The generating of the patch ID may include calculating a first patch element and a second patch element of the plurality of components, and generating the patch ID by adding the second patch element to a value obtained by multiplying the first patch element by a stride of the filter matrix, the first patch element may be a quotient output when a row element of the plurality of components is divided by the number of columns of the output data matrix, and the second patch element may be a quotient output when a column element of the plurality of components is divided by the number of columns of the filter matrix, the row element may be a quotient output when the array index is divided by a size of the filter matrix, and the column element may be a remainder output when the array index is divided by the size of the filter matrix.

The generating of the element ID may include generating the element ID by adding a remainder value output when the row element is divided by a value obtained by multiplying the number of columns of the output data matrix by the number of channels and the stride, and a remainder value output when the column element is divided by a value obtained by multiplying the number of columns of the filter matrix by the number of channels, to the offset, and the offset of the input data matrix may be a value obtained by multiplying the patch ID by the number of columns and the number of channels of the input data matrix.

The convolutional operation method may further include generating, by the at least one processor, the input data matrix by changing a size of an original input data matrix and a number and an order of a plurality of components into a memory region corresponding to a workspace, and the input data matrix may be a matrix in which the plurality of components of the original input data matrix are recombined and arranged with a rule so that the original input data matrix outputs the feature data matrix through the filter matrix and the GEMM operation.

The generating of the input data matrix may include generating the input data matrix by converting the original input data matrix into the workspace having a same number of rows as a number of rows of the feature data matrix and a same number of columns as a size of the filter matrix.

The updating of the register mapping table may include receiving tensor core load data, identifying whether an identifier of a component having a first destination register address and a second destination register address included in the tensor core load data are recorded in a load history buffer, when the identifier and the second destination register address are not recorded in the load history buffer, accessing a memory and fetching data of the component from a memory layer, recording a second destination register address of a register in which the identifier and the fetched data are stored in the load history buffer, and updating the register mapping table so that the second destination register address recorded in the load history buffer corresponds to the first destination register address, and when the identifier and the second destination register address are recorded in the load history buffer, updating the register mapping table so that the second destination register address recorded in the load history buffer corresponds to the first destination register address without accessing the memory.

According to one or more embodiments, a computer program is stored in a computer-readable recording medium to execute the convolutional operation method.

According to one or more embodiments, a convolutional operation device includes a memory storing a register mapping table, and a processor configured to perform a convolutional operation for generating a feature data matrix corresponding to an output data matrix by performing a general matrix multiplication (GEMM) operation on an input data matrix with a set filter matrix, wherein the processor is further configured to update a register mapping table so that first destination register addresses of redundant components indicating pieces of data redundant with each other among a plurality of components of the input data matrix correspond to a same second destination register address, and perform the convolutional operation by reusing a register having the same second destination register address with respect to the redundant components, based on the register mapping table.

The processor may be further configured to generate an identifier of the plurality of components, update the register mapping table so that first destination register addresses of components for which a same identifier is generated among the plurality of components correspond to a same second destination register address.

The identifier may include an element ID, and the processor may be further configured to generate a patch ID of the plurality of components based on an array index of the plurality of components, a number of rows and columns of the filter matrix, and a number of columns of the output data matrix, and generate an element ID of the plurality of components based on the patch ID and an offset of the plurality of components, and the offset may be a value determined based on the patch ID, the number of columns and a number of channels of the input data matrix, and the array index may be a value indicating a location of each component when the plurality of components are arranged in a single-dimensional array.

The identifier may further include a batch ID, and the processor may be further configured to generate the batch ID of the plurality of components based on the array index of the plurality of components, the number of rows and the number of columns of the filter matrix, and a number of rows and the number of columns of the output data matrix.

The processor may be further configured to calculate a first patch element and a second patch element of the plurality of components, generate the patch ID by adding the second patch element to a value obtained by multiplying the first patch element by a stride of the filter matrix, the first patch element may be a quotient output when a row element of the plurality of components is divided by the number of columns of the output data matrix, and the second patch element may be a quotient output when a column element of the plurality of components is divided by the number of columns of the filter matrix, the row element may be a quotient output when the array index is divided by a size of the filter matrix, and the column element may be a remainder output when the array index is divided by the size of the filter matrix.

The processor may be further configured to generate the element ID by adding a remainder value output when the row element is divided by a value obtained by multiplying the number of columns of the output data matrix by the number of channels and the stride, and a remainder value output when the column element is divided by a value obtained by multiplying the number of columns of the filter matrix by the number of channels, to the offset, and the offset of the input data matrix may be a value obtained by multiplying the patch ID by the number of columns and the number of channels of the input data matrix.

The processor may be further configured to generate the input data matrix by changing a size of an original input data matrix and a number and an order of a plurality of components into a memory region corresponding to a workspace, the input data matrix may be a matrix in which the plurality of components of the original input data matrix are recombined and arranged with a rule so that the original input data matrix outputs the feature data matrix through the filter matrix and the GEMM operation.

The processor may be further configured to generate the input data matrix by converting the original input data matrix into the workspace having a same number of rows as a number of rows of the feature data matrix and a same number of columns as a size of the filter matrix.

The processor may be further configured to receive tensor core load data, identify whether an identifier of a component having a first destination register address and a second destination register address included in the tensor core load data are recorded in a load history buffer, when the identifier and the second destination register address are not recorded in the load history buffer, fetch data of the component, record a second destination register address of a register in which the identifier and the fetched data are stored in the load history buffer, and update the register mapping table so that the second destination register address recorded in the load history buffer corresponds to the first destination register address, and when the identifier and the second destination register address are recorded in the load history buffer, update the register mapping table so that the second destination register address recorded in the load history buffer corresponds to the first destination register address.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of a convolutional operation device according to an embodiment;

FIG. 2 is another block diagram of the convolutional operation device according to an embodiment;

FIG. 3 is a table showing the use of a load history buffer according to an embodiment;

FIG. 4 is a diagram illustrating configurations of an ID generator and a load history buffer according to an embodiment;

FIGS. 5A to 5D are diagrams illustrating identifying whether a second destination register address is recorded in the load history buffer according to an embodiment;

FIG. 6 is a diagram illustrating performing a convolutional operation on an original input data matrix with a filter matrix according to an embodiment;

FIG. 7 is a diagram illustrating an input data matrix converted into a workspace according to an embodiment;

FIG. 8 is a diagram illustrating a matrix in which components of an input data matrix are recombined and arranged with a rule according to an embodiment;

FIG. 9 is another diagram illustrating a matrix in which components of an input data matrix are arranged with a rule according to an embodiment;

FIGS. 10A and 10B are diagrams illustrating a patch ID of a plurality of components of an input data matrix generated according to an embodiment;

FIG. 11 is a diagram illustrating an element ID of a plurality of components of an input data matrix generated according to an embodiment;

FIG. 12 is a diagram illustrating configurations of an ID generator and a load history buffer according to another embodiment;

FIG. 13 is a flowchart of a convolutional operation method according to an embodiment; and

FIGS. 14A and 14B are graphs showing the effect of a convolutional operation method of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Like reference numerals refer to like elements throughout the specification. This specification does not describe all elements of the embodiments, and general descriptions in the technical field to which the disclosed invention pertains or redundant descriptions between the embodiments are omitted. The term ‘˜module’ used in the specification may be implemented in software or hardware, and according to embodiments, a plurality of ‘˜modules’ may be implemented as one component, or one ‘module’ may also include a plurality of components.

Also, when a part “includes” a component, it means that other components may be further included, rather than excluding other components, unless otherwise stated.

Terms such as first, second, etc. are used to distinguish one component from another, and the component is not limited by the above-mentioned terms.

The singular expression includes the plural expression unless the context clearly dictates otherwise.

In each operation, a reference numeral is used for convenience of description, the reference numeral does not describe the order of each operation, and each operation may be performed differently from the specified order unless the specific order is clearly stated in the context.

Hereinafter, the operation principle and embodiments of the disclosed invention will be described with reference to the accompanying drawings.

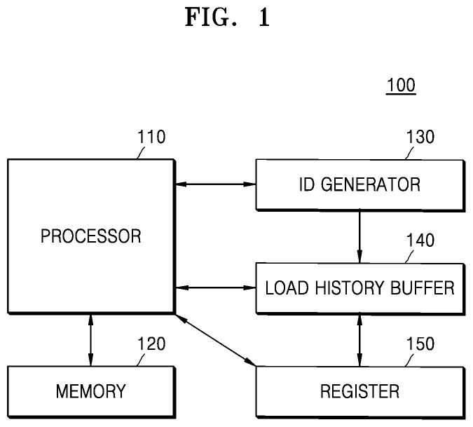

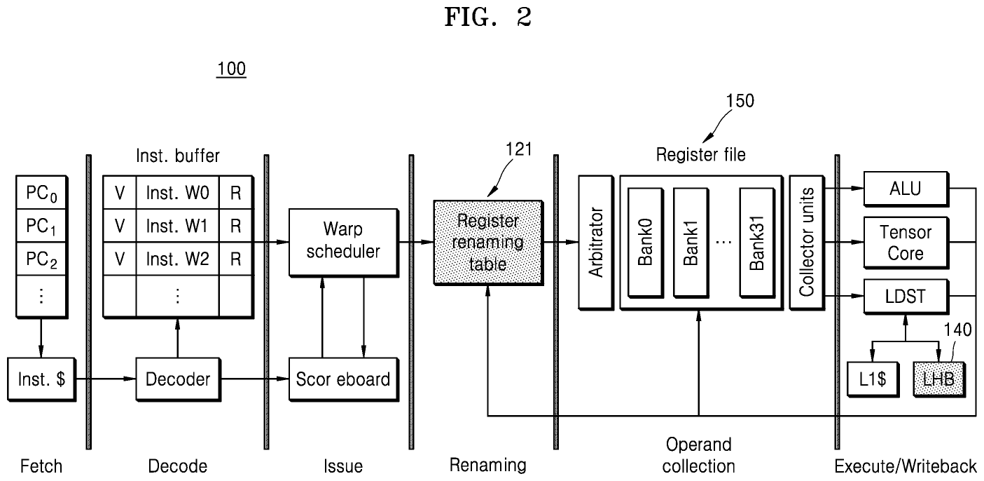

FIG. 1 is a block diagram of a convolutional operation device 100 according to an embodiment, and FIG. 2 is another block diagram of the convolutional operation device 100 according to an embodiment.

Referring to FIG. 1, the convolutional operation device 100 according to an embodiment of the present disclosure may include a processor 110, a memory 120, an ID generator 130, a load history buffer 140, and a register 150.

The processor 110 may perform a convolutional operation. Specifically, the processor 110 may generate a feature data matrix corresponding to an output data matrix by performing a general matrix multiplication (GEMM) operation with a filter matrix set on an input data matrix so as to perform the convolutional operation.

Here, the input data matrix may be a matrix in which the original input data matrix is converted into a workspace. Specifically, the input data matrix may be a matrix in which a plurality of components of the original input data matrix are recombined and arranged with a rule so that the original input data matrix may output the feature data matrix through the filter matrix and the GEMM operation. The feature data matrix may be a matrix corresponding to the output data matrix generated by the convolutional operation. Specifically, the feature data matrix may be a result value obtained when the input data matrix is used as an input value in the GEMM operation in which the set filter matrix is used. Also, the feature data matrix may be a matrix of one column.

The memory 120 may store a register mapping table set based on a data rule of a plurality of components of the input data matrix.

The processor 110 may update the register mapping table stored in the memory 120.

Specifically, the processor 110 may update the register mapping table so that first destination register addresses of redundant components indicating redundant data among the plurality of components of the input data matrix correspond to the same second destination register address.

Here, the redundant component may be a component redundant with another among components of the input data matrix.

Specifically, in a process of converting the original input data matrix into the workspace, the size of the matrix may be expanded, and a specific component in the original input data matrix may be redundantly arranged by changing positions. As such, among the components of the input data matrix, the components converted based on the same component of the original input data matrix may be redundant with each other.

In addition, the processor 110 may be configured to perform the convolutional operation between the input data matrix and the filter matrix by reusing the register 150 having the same second destination register address with respect to the redundant components, based on the register mapping table.

That is, in that the components of the input data matrix include redundant components, when data currently required to perform the GEMM operation has already been fetched from the memory 120, the register 150 in which the corresponding data is stored may exist.

In this case, the processor 110 may prevent unnecessary access to the memory 120 in that the processor 110 does not need to access the memory 120 again to fetch the corresponding data, but performs the GEMM operation by fetching the corresponding data from the register 150 in which the corresponding data is stored.

Referring to FIG. 2, the convolutional operation device 100 may include a register mapping table 121.

The register mapping table 121 may be a table indicating a correspondence relationship between a plurality of first destination register addresses and a plurality of second destination register addresses.

A first destination register address may mean a logical address or a virtual address corresponding to each of a plurality of components of the input data matrix.

A second destination register address may mean a physical address corresponding to each of the plurality of registers 150.

In addition, the second destination register address with respect to the corresponding component may be identically set with respect to the corresponding component and a component redundant with the corresponding component.

Specifically, since the first destination register address corresponds to each of the plurality of components of the input data matrix, the first destination register address may be different for each component of the input data matrix. For example, a first destination register address of a component of a first row and a second column of the input data matrix may be different from a first destination register address of a component of a second row and a first column of the input data matrix.

On the other hand, the second destination register address may be set identically with respect to the redundant components. That is, if the component of a first row and a second column of the input data matrix and the component of a second row and a first column of the input data matrix are redundant components, the first destination register address of the component of the first row and the second column of the input data matrix and a second destination register address of the component of the second row and the first column of the input data matrix may be the same.

In addition, first destination register addresses may have corresponding second destination register addresses, respectively. That is, data of the component corresponding to the first destination register address is stored or may be stored in the register 150 having the second destination register address corresponding to the first destination register address, and a correspondence relationship between the first destination register address and the second destination register address may be shown in the register mapping table 121.

The processor 110 may perform the convolutional operation by reusing the register 150 having the same second destination register address with respect to the redundant components, based on the register mapping table 121.

Specifically, the processor 110 may convert the first destination register address into the corresponding second destination register address, based on the register mapping table 121.

In addition, when the processor 110 performs an operation in which data of a specific first destination register component among the plurality of components of the input data matrix is used, the processor 110 may perform the operation by obtaining the corresponding data from the register 150 having the second destination register address converted from the corresponding first destination register address.

The ID generator 130 may generate identifiers of the plurality of components of the input data matrix. Here, the identifiers may be generated one by one with respect to each of the plurality of elements of the input data matrix. In this case, the ID generator 130 may generate the same identifier with respect to the redundant components among the plurality of components of the input data matrix.

Specifically, the ID generator 130 may generate the same identifier to the redundant components, based on a memory address of a load instruction and factors (size/width/channel number of the input data matrix, filter size/width/movement distance, etc.) of the convolutional operation, and thus, it may be determined whether there is redundancy between the plurality of components of the input data matrix. To this end, the ID generator 130 may be programmed in accordance with the corresponding factors when the convolutional operation starts.

The processor 110 may update the register mapping table 121 based on the identifiers. That is, the processor 110 may update the register mapping table 121 so that the first destination register address of components having the same identifier among the plurality of components of the input data matrix correspond to the same second destination register.

The load history buffer 140 may store identifiers of previously loaded components and a second destination register address of a register in which the corresponding component is stored.

Then, when receiving a load command with respect to a specific component of the input data matrix, the processor 110 may confirm through the load history buffer 140 whether there is a record for a component having the same identifier as that of the corresponding component among previous records, based on the identifier generated by the ID generator 130.

In addition, when it is confirmed that the record for the component having the same identifier exists in the load history buffer 140, the processor 110 may reuse the value stored in the register 150 having the second destination register address notified by the load history buffer 140, instead of reading data of the corresponding component from the memory 120, thereby removing unnecessary memory access of repeatedly reading redundant data.

As such, the convolutional operation method of the present disclosure has the effect of remarkably increasing the number of data reuses by efficiently detecting and using redundant data located at different memory addresses in a deep artificial neural network using the convolutional operation. As a result, the technology proposed by the present disclosure may improve the performance of a general-purpose graphics processing device by reusing a large amount of data and removing unnecessary memory access.

The ID generator 130 may include any one of the plurality of processors 110 included in the convolutional operation device 100. In addition, the convolutional operation method according to the embodiment of the present disclosure described above and the embodiment which will be described below may be implemented in the form of a program that may be driven by the processor 110 and the ID generator 130.

Here, the program may include program command, data files, data structures, etc. alone or in combination. The program may be designed and manufactured using machine code or high-level language code. The program may be specially designed to implement the above-described code correction method, or may be implemented using various functions or definitions that are known and available to those skilled in the computer software field. A program for implementing the above-described information display method may be recorded on a recording medium readable by the processor 110 and the ID generator 130. In this regard, the recording medium may be the memory 120.

The memory 120 may store a program performing the above-described operation and an operation which will be described below, and the memory 120 may execute the stored program. When the processor 110 and the memory 120 are plural, they may be integrated into one chip or may be provided in physically separate locations. The memory 120 may include a volatile memory such as static random access memory (S-RAM) or dynamic random access memory (D-RAM) temporarily storing data. In addition, the memory 120 may include a non-volatile memory such as Read Only Memory (ROM), Erasable Programmable Read Only Memory (EPROM), Electrically Erasable Programmable Read Only Memory (EEPROM), etc. storing control programs and control data for a long period of time.

The processor 110 and the ID generator 130 may include various logic circuits and arithmetic circuits, process data according to the program provided from the memory 120, and generate a control signal according to a processing result.

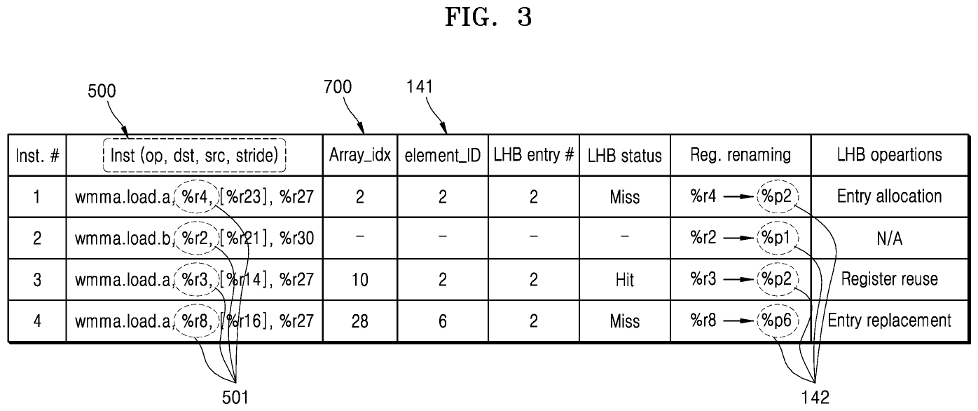

FIG. 3 is a table showing the use of a load history buffer according to an embodiment.

The conventional technology utilizes the locality of data by using a cache, but in the data of a deep artificial neural network, since data of the same redundant component is located in different memory addresses, the locality of data may not be utilized at all with a general cache. On the other hand, the convolutional operation method of the present disclosure may maximize the effect of detecting and removing redundant data by allocating data of the same redundant components to the same core considering various factors.

Referring to FIG. 3, tensor core load data 500 may include a first destination register address 501.

The processor 110 may receive the tensor core load data 500. Specifically, the processor 110 may receive the tensor core load data 500 with respect to a convolutional operation process currently in progress.

The tensor core load data 500 may be data included in a tensor core load command. In this regard, the processor 110 may load redundant data that has already been used in a previous operation and stored in the register 150 based on the tensor core load command.

Each of the pieces of tensor core load data 500 may include one first destination register address 501. Specifically, the tensor core load command may include an instruction to load data of a component of the first destination register address 501 in order to perform a convolutional operation.

That is, when any one tensor core load command is input, data of a specific component of an input data matrix corresponding to the first destination register address included in the corresponding tensor core load instruction may have to be loaded.

In addition, each of the pieces of tensor core load data 500 may correspond to one array index 700. In this regard, the array index 700 may be a factor with respect to a location in a matrix of the component that needs to be loaded.

Specifically, the array index 700 may be a value indicating a location of each component when a plurality of components of the input data matrix are arranged in a single-dimensional array.

As a result, the array index 700 may be information about a location of a component required by the tensor core load command in the input data matrix. Also, each array index 700 may correspond to one first destination register address.

The processor 110 may generate identifiers of the plurality of components of the input data matrix.

In addition, the processor 110 may update the register mapping table 121 so that the first destination register addresses 501 of the plurality of components of the input data matrix, in which the same identifier is generated, correspond to the same second destination register address 142.

Here, the identifier according to an embodiment of the present disclosure may include an element ID 141, as shown in FIG. 3.

Here, the element ID 141 of the input data matrix component required for an operation of the tensor core load command may be generated based on a location of a component required for the corresponding operation in the matrix, that is, the array index 700.

For example, referring to FIG. 3, the processor 110 may generate ‘2’ that is the element ID 141 of the component corresponding to ‘r4’ that is the first destination register address 501 included in the received tensor core load data 500.

In addition, the processor 110 may generate ‘10’ that is the element ID 141 of the component corresponding to ‘r3’ that is the first destination register address 501 included in the received tensor core load data 500.

In addition, the processor 110 may generate ‘6’ that is the element ID 141 of the component corresponding to ‘r8’ that is the first destination register address 501 included in the received tensor core load data 500.

Then, the processor 110 may determine the second destination register address 142 based on the element ID 141 of the input data matrix component. Specifically, the processor 110 may determine the second destination register address 142 so that the second destination register addresses 142 of components having the same element ID 141 have the same value.

In addition, the processor 110 may update the register mapping table 121 so that the determined second destination register address 142 corresponds to the first destination register address 501 of the corresponding components.

For example, referring to FIG. 3, when it is determined that the element ID 141 corresponding to the first destination register address 501 of the received tensor core load data 500 is ‘2’, and the second destination register address 142 corresponding thereto is ‘p2’, the processor 110 may update the register mapping table 121 such that ‘p2’, which is the second destination register address 142, corresponds to ‘r4’, which is the first destination register address 501.

In addition, when it is determined that the element ID 141 corresponding to the first destination register address 501 of the received tensor core load data 500 is ‘6’, and the second destination register address 142 corresponding thereto is ‘p6’, the processor 110 may update the register mapping table 121 such that ‘p6’, which is the second destination register address 142, corresponds to ‘r8’, which is the first destination register address 501.

There may have been a tensor core load command indicating the same element ID 141 as the element ID 141 corresponding to the component of the input data matrix used in the currently input tensor core load instruction.

In this case, the processor 110 may update the register mapping table 121 so that the second destination register address 142 corresponding to the first destination register address 501 of the component of the currently input tensor core load command is the same as a second destination register address 142 corresponding to the first destination register address 501 of a component of a previous tensor core load instruction.

Accordingly, the processor 110 may perform an operation of the currently received tensor core load instruction by using the same register as a register used in the previous tensor core load command.

For example, referring to FIG. 3, in the case of a third received tensor core load command, the element ID 141 is ‘2’, which is ‘2’ that is the element ID 141 of a first received tensor core load instruction. Accordingly, the processor 110 may update the second destination register address 142 corresponding to the first destination register address ‘r3’ included in the third received tensor core load command to be ‘p2’.

Accordingly, the processor 110 may perform a matrix operation by using data stored in the register 150 in which the second destination register address 142 that has been used for the operation for the first tensor core load command is ‘p2’, without having to access the memory 120 in order to load data used for the operation for the third received tensor core load command.

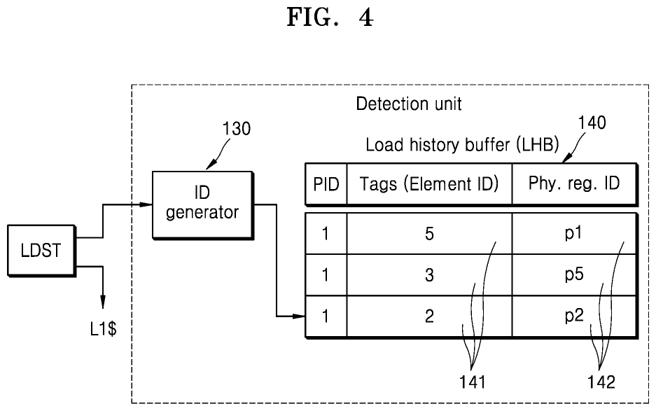

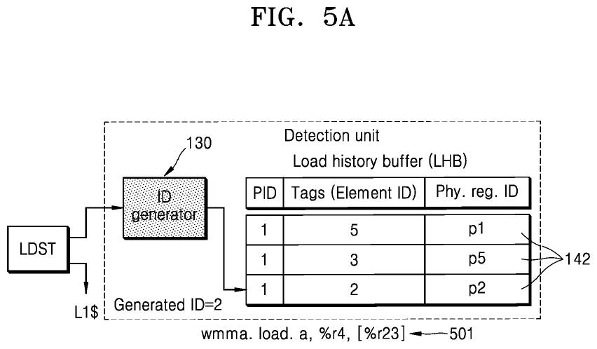

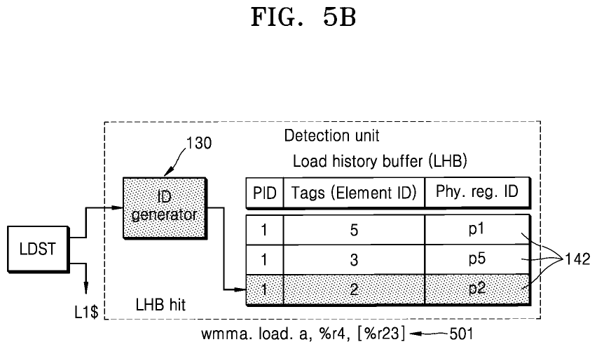

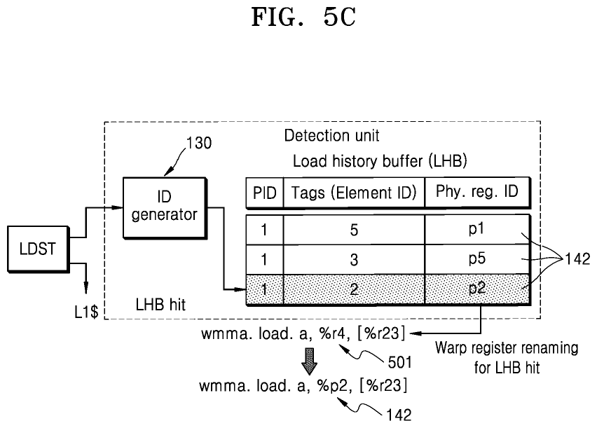

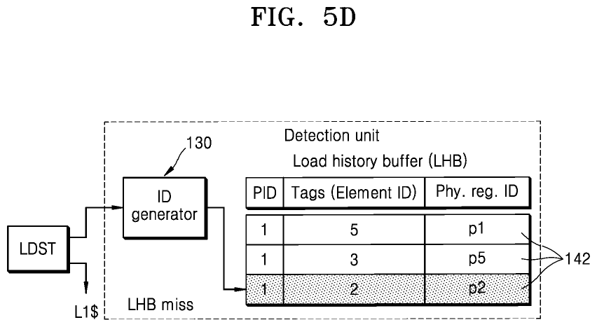

FIG. 4 is a diagram illustrating configurations of the ID generator 130 and the load history buffer 140 according to an embodiment, and FIGS. 5A to 5D are diagrams illustrating identifying whether the second destination register address 142 is recorded in the load history buffer 140 according to an embodiment.

Referring to FIG. 4, the convolutional operation device 100 may include a detection unit that may confirm data redundancy in a general-purpose graphics processing device. In addition, the processor 110 may include the detection unit.

A sensing unit may confirm whether the processor 110 has already accessed the same memory data, and record where the corresponding data is stored in a register file. The detection unit may include the ID generator 130 that may confirm data redundancy, and the load history buffer 140 that tracks the history of a memory load instruction.

The ID generator 130 may generate the element ID 141 of a component of an input data matrix required for a current matrix operation. In addition, the generated element ID 141 and the second destination register address 142 corresponding thereto may be recorded in the load history buffer 140.

Referring to FIGS. 5A to 5D, the detection unit, that is, the processor 110, may identify whether the element ID 141 of the component of the input data matrix required for the current matrix operation and the second destination register address 142 corresponding thereto are recorded in the load history buffer 140.

When the element ID 141 of the component of the input data matrix required for the current matrix operation and the second destination register address 142 corresponding thereto are recorded in the load history buffer 140, the processor 110 may update the register mapping table 121 so that the corresponding second register address 142 corresponds to the first destination register address 501 of the corresponding component.

Accordingly, the processor 110 may reuse data stored in the register 150 having the second destination register address 142 recorded in the load history buffer 140 without accessing the memory 120, in order to load data of the component of the input data matrix required for a current matrix operation, based on the register mapping table 121.

For example, referring to FIGS. 5A, 5B, and 5C, the element ID 141 of an input data component required for a current operation may be ‘2’, and the second destination register address 142 corresponding thereto may be ‘p2’. At this time, when the element ID ‘2’ and the second destination register address 142 ‘p2’ are recorded in the load history buffer 140, the processor 110 may reuse data stored in the register 150 having the second destination register address ‘p2’ recorded in the load history buffer 140 without accessing the memory 120.

On the other hand, when the element ID 141 of the component of the input data matrix required for the current matrix operation and the second destination register address 142 corresponding thereto are not recorded in the load history buffer 140, the processor 110 may access the memory 120 to fetch the data of the component of the input data matrix required for the current operation from a memory layer.

Then, the processor 110 may record the corresponding element ID 141 and the second destination register address of the register 150, to which the corresponding data is fetched, to the load history buffer 140, and may update the register mapping table 121 so that the recorded second destination register address 142 corresponds to the first destination register address 501 of the component of the input data matrix required for the current operation.

For example, referring to FIG. 5D, the element ID 141 of the input data component required for the current operation may be ‘2’, and the first destination register address 501 of the corresponding component may be ‘r4’. At this time, when the element ID 141 of ‘2’ and the second destination register address 142 of ‘p2’ are not recorded in the load history buffer 140, the processor 110 may access the memory 120 and fetch data of the first destination register address ‘r4’ from the memory layer (L1$).

In addition, the processor 110 may record the element ID ‘2’ and the second destination register address 142 ‘p2’ of the register 150, in which the fetched data is stored, to the load history buffer 140.

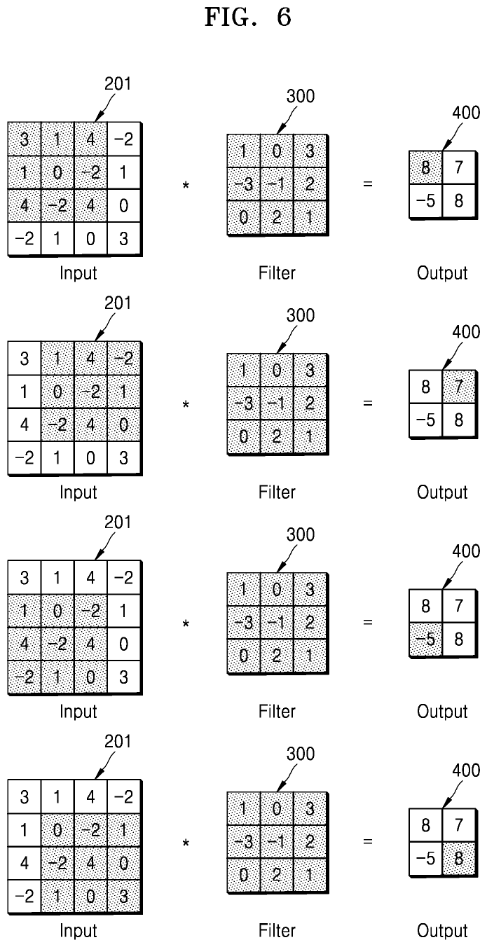

FIG. 6 is a diagram illustrating performing a convolutional operation on an original input data matrix with a filter matrix according to an embodiment.

Referring to FIG. 6, an example of a convolutional operation process in which the original input data matrix 201 is a matrix having a size of 4×4 and the filter matrix 300 is a matrix having a size of 3×3 may be confirmed.

At this time, it may be confirmed that four matrix operations are performed during one convolutional operation process, and the output data matrix 400 having a size of 2×2 is output. That is, it may be confirmed that several matrix multiplication operations occur for one convolutional operation. Therefore, in order to reduce the number of operations, it may be necessary to convert the original input data matrix 201 so that the output data matrix 400 may be output through one matrix multiplication operation.

The output data matrix 400 may be a result value resulting from a convolutional operation when the original input data matrix 201 is used as an input value. That is, the feature data matrix 401 may be a matrix in which components of the output data matrix 400 are sequentially arranged to form one column.

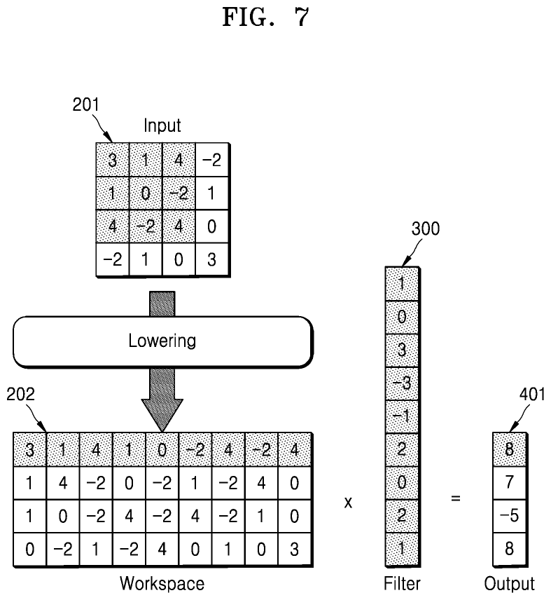

FIG. 7 is a diagram illustrating an input data matrix 202 converted into a workspace according to an embodiment.

Referring to FIG. 7, the processor 110 may generate the input data matrix 202 converted into the workspace by changing the size of the original input data matrix 201, the number of components, and the order of components to a memory region corresponding to the workspace in order to perform a convolution through a GEMM operation.

In this case, the processor 110 may generate the input data matrix 202 by converting the original input data matrix 201 into the workspace having the same number of rows as the number of rows of the feature data matrix 401 and the same number of columns as the size of the filter matrix 300.

For example, when the number of rows of the feature data matrix 401 is 4 and the size of the filter matrix 300 is 9, the number of rows of the input data matrix 202 converted to the workspace may be 4 and the number of columns thereof may be 9.

Accordingly, the processor 110 may convert the original input data matrix 201 into the input data matrix 202 that is converted to the workspace so as to output the feature data matrix 401 through one matrix operation with the filter matrix 300.

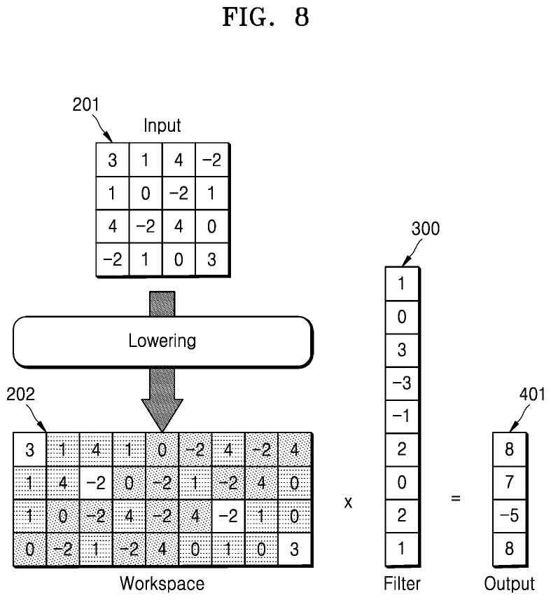

FIG. 8 is a diagram illustrating a matrix in which components of the input data matrix 202 are recombined and arranged with a rule according to an embodiment.

Referring to FIG. 8, the input data matrix 202 converted to a workspace may be the matrix in which components of the original input data matrix 201 are recombined and arranged with the rule, so that the feature data matrix 401 may be output through one matrix operation with the filter matrix 300 in a memory region.

Specifically, referring to the input data matrix 202 converted into the workspace of FIG. 8, a component of a first row and a second column and a component of a second row and a first column may be redundant components in the matrix, and a component of the first row and a third column and a component of the second row and a second column may be redundant components.

In addition, a component of the first row and an eighth column, a component of the second row and a seventh column, a component of a third row and a fifth column, and a component of a fourth row and a fourth column may be redundant components that are redundant with each other.

Since the input data matrix 202 converted to the workspace is the matrix in which the redundant components are arranged with a specific rule, it may be possible to generate the same element ID 141 with respect to the redundant components if the rule is used.

In other words, even if different components are at different locations on the input data matrix 202 converted to the workspace, if different components were originally the same components in the original input data matrix 201, the corresponding redundant components may be arranged with the specific rule on the input data matrix 202 converted to the workspace. In this regard, if the same element ID 141 is generated with respect to the redundant components and data stored in the redundant components may be called from the same register 150, it may be possible to reduce the amount of computations and save energy.

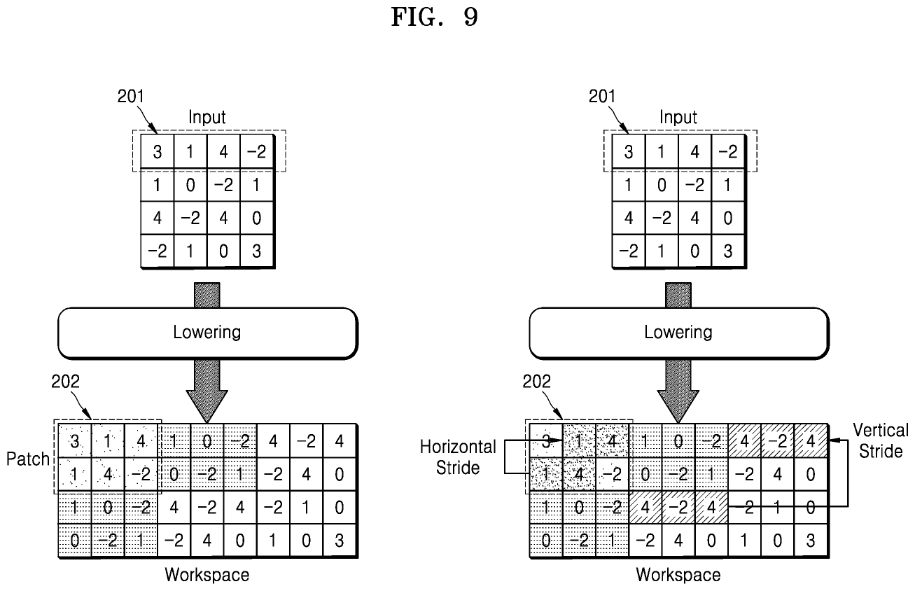

FIG. 9 is another diagram illustrating a matrix in which components of the input data matrix 202 are arranged with a rule according to an embodiment.

A patch may be a sub-matrix of the input data matrix 202 converted into a workspace.

Referring to FIG. 9, the input data matrix 202 converted into the workspace may include six patches, which each is a matrix of size 2×3. At this time,

one patch may be a rearrangement of constituent components of any one row of the original input data matrix 201.

For example, when component data of the first row of the original input data matrix 201 are ‘3’, ‘1,’ ‘4’, and ‘−2’ in order, component data of a first patch may be ‘3’, ‘1’, ‘4’, ‘1’, ‘4’, and ‘−2’.

In addition, when component data of the third row of the original input data matrix 201 are ‘4’, ‘−2’, ‘4’, and ‘0’ in order, component data of a third patch may be ‘4’, ‘−2’, ‘4’, ‘−2’, ‘4’, or ‘0’.

Moreover, a component of the third row of the original input data matrix 201 may not appear only in a component of the third patch. Referring to the drawing, it may be confirmed that the component of the third row of the original input data matrix 201 also appears in a component of a fifth patch.

Similarly, referring to the drawing, a component of a second patch and a component of a fourth patch correspond to each other, from which it may be confirmed that components of the second row of the original input data matrix 201 are rearranged.

As such, the input data matrix 202 converted to the workspace may be a matrix in which a plurality of patches are arranged with a rule so that the feature data matrix 401 may be output through one matrix operation with the filter matrix 300.

Accordingly, the processor 110 may update the mapping table 121 so that first destination register addresses of redundant components indicating redundant data among the plurality of components of the input data matrix 202 correspond to the same second destination register address, based on such a rule.

Specifically, the processor 110 may generate identifiers of the plurality of components of the input data matrix 202 converted into the workspace. In addition, the processor 110 may update the register mapping table 121 so that the first destination register addresses, to which the same identifier is generated among the plurality of components, correspond to the same second destination register address.

To this end, the ID generator 130 may generate patch IDs of the plurality of components of the input data matrix 202, based on an array index of the plurality of components of the input data matrix 202, the number of rows and columns of a filter matrix, and the number of columns of an output data matrix.

In addition, the ID generator 130 may generate element IDs of the plurality of components, based on a patch ID and an offset of the component of the input data matrix 202.

Here, the patch ID may be a value determined based on the number of columns of the input data matrix and the number of channels.

In addition, the array index may be a value indicating a location of each component when the plurality of components are arranged in a single-dimensional array.

Hereinafter, a method in which the ID generator 130 generates the element ID 141 with respect to the plurality of components of the input data matrix 202 will be described in detail.

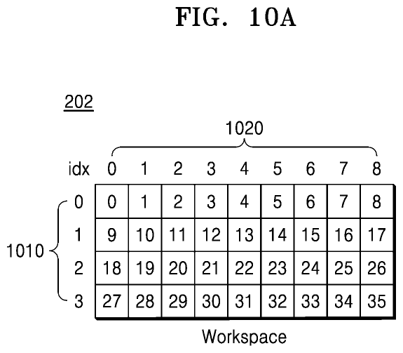

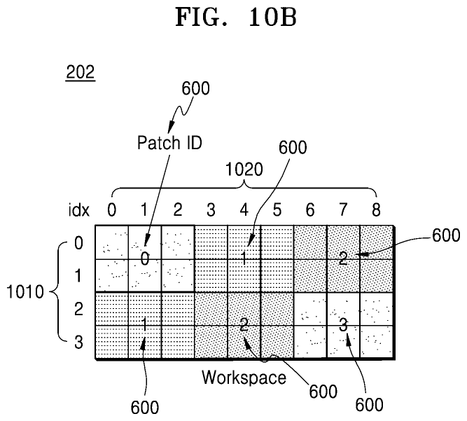

FIG. 10B is a diagram illustrating a patch ID 600 of a plurality of components of the input data matrix 202 generated according to an embodiment. Here, it is assumed that the filter matrix 300 and the output data matrix 400 are the same as in FIG. 6.

The ID generator 130 may generate the patch ID 600 of the plurality of components of the input data matrix 202, based on an array index of the plurality of components of the input data matrix 202, the number of rows and columns of the filter matrix 300, and the number of columns of the output data matrix 400.

To this end, the ID generator 130 may allocate the array index of the plurality of components of the input data matrix 202.

For example, as shown in FIG. 10A, array index values of 0 to 8 may be sequentially allocated to components from the first row and the first column to the first row and the ninth column of the input data matrix 202, array index values of 9 to 17 may be sequentially allocated to components from the second row and the first column to the second row and the ninth column, array index values of 18 to 26 may be sequentially allocated to components from the third row and the first column to the ninth column, and array index values of 27 to 35 may be sequentially allocated to components from the fourth row and the first column to the ninth column.

In addition, the ID generator 130 may calculate a row element 1010 and a column element 1020 of the plurality of components of the input data matrix 202.

The row element 1010 of the component of the input data matrix 202 may be a quotient that is output when the array index value, in which the corresponding component is located, is divided by the size (the number of columns of the filter matrix 300×the number of rows of the filter matrix 300) of the filter matrix 300.

For example, as shown in FIG. 10A, the array index value of a component located in the second row and the third column of the input data matrix 202 may be 11. In addition, the array index value of a component located in the fourth row and the fifth column may be 31.

At this time, since the size of the filter matrix 300 is 9, the row element of the component located in the second row and the third column may be 1, which is a quotient output when 11 is divided by 9, and the row element 1010 of a component located in the fourth row and the fifth column may be 3, which is a quotient output when 31 is divided by 9.

The column element 1020 of the component of the input data matrix 202 may be the remainder that is output when the array index value, in which the corresponding component is located, is divided by the size (the number of columns of the filter matrix 300×the number of rows of the filter matrix 300) of the filter matrix 300.

For example, an array index value of a component located in the second row and the third column of the input data matrix 202 may be 11. In addition, an array index value of a component located in the fourth row and the fifth column may be 31.

At this time, since the size of the filter matrix 300 is 9, a column element of the component located in the second row and the third column may be 2, which is the remainder output when 11 is divided by 9, and the column element 1020 of the component located in the fourth row and the fifth column may be 4, which is the remainder output when 31 is divided by 9.

In addition, the ID generator 130 may calculate a first patch element and a second patch element for each component of the input data matrix 202.

The first patch element may be a quotient output when a row element of a component of the input data matrix 202 is divided by the number of columns of the output data matrix 400.

For example, as shown in FIG. 10A, in the input data matrix 202, the row element of the component located in the second row and the third column may be 1. Also, the row element of the component located in the fourth row and the fifth column may be 3.

At this time, since the number of columns of the output data matrix 400 is 2, the first patch element of the component located in the second row and the third column may be 0, which is a quotient output when 1 is divided by 2, and the first patch element of the component located in the fourth row and the fifth column may be 1, which is a quotient output when 3 is divided by 2.

The second patch element may be a quotient output when a column element of a component of the input data matrix 202 is divided by the number of columns of the filter matrix 300.

For example, in the input data matrix 202 of FIG. 10A, the column element of the component located in the second row and the third column may be 2. Also, the column element of the component located in the fourth row and the fifth column may be 4.

In this case, since the number of columns of the filter matrix 300 is 3, the second patch element of the component located in the second row and the third column may be 0, which is a quotient output when 2 is divided by 3. The second patch element of the component located in the fourth row and the fifth column may be 1, which is a quotient output when 4 is divided by 3.

The ID generator 130 may generate the patch ID 600 by adding the second patch element to a value obtained by multiplying the first patch element by a stride of the filter matrix 300.

For example, assuming that the stride of the filter matrix 300 is 1, as shown in FIG. 10B, the patch ID 600 of the component located in the second row and the third column in the input data matrix 202 may be 0, which is a value obtained by adding 0 to a value obtained by multiplying 0 by 1. Also, the patch ID 600 of the component located in the fourth row and the fifth column may be 2, which is a value obtained by adding 1 to a value obtained by multiplying 1 by 1. On the other hand, the above-described method is only an example of obtaining the patch ID 600 with respect to any component of the input data matrix 202, and even if the patch ID 600 is generated using a completely different method, there is no problem if the same element ID 141 may be generated with respect to redundant components by using the patch ID 600.

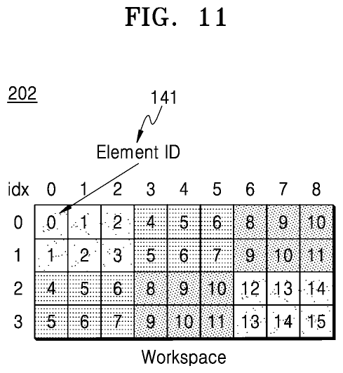

FIG. 11 is a diagram illustrating an element ID of a plurality of components of the input data matrix 202 generated according to an embodiment. Here, it is assumed that the original data matrix 201, the filter matrix 300, and the output data matrix 400 are as shown in FIG. 6, and the patch ID 600 is generated as shown in FIGS. 10A and 10B.

The ID generator 130 may generate the same element ID 141 with respect to components of the input data matrix 202 indicating redundant data based on the patch ID 600.

Specifically, the ID generator 130 may generate the same element ID 141 with respect to the components of the input data matrix 202 indicating the redundant data, based on an offset of the component of the input data matrix 202.

Here, the offset of the component of the input data matrix 202 may be a value obtained by multiplying the patch ID 600 of the component of the input data matrix 202 by the number of columns and the number of channels of the original input data matrix 202.

For example, assuming that the number of channels in the original input data matrix 202 is 1, as shown in FIG. 10B, since in the input data matrix 202, the patch ID 600 of a component located in the second row and the third column is 0, an offset of a component located in the second row and the third column may be 0, which is a value obtained by multiplying 0 by 4, which is the number of columns of the input data matrix 200, and 1, which is the number of channels.

In addition, since in the input data matrix 202, the patch ID 600 of a component located in the fourth row and the fifth column is 2, an offset of the component located in the fourth row and the fifth column may be 8, which is a value obtained by multiplying 2 by 4, which is the number of columns of the input data matrix 200, and 1, which is the number of channels.

Then, the ID generator 130 may generate the element ID 141 of the component of the input data matrix 202, by adding a remainder value output when the row element 1010 of the component of the input data matrix 202 is divided by a value obtained by multiplying the number of columns of the output data matrix 400 by the number of channels and the stride, and a remainder value output when the column element 1020 of the component of the input data matrix 202 is divided by a value obtained by multiplying the number of columns of the filter matrix 300 by the number of channels, to the offset of the component of the input data matrix 202.

For example, referring to FIG. 11, assuming that each of the stride of the matrix 300 and the number of channels of the original input data matrix 202 is 1, a remainder value output when row element 1 of the component in the second row and the third column is divided by 2, which is a value obtained by multiplying column number 2 of the output data matrix 400 by channel number 1 and stride 1, may be 1.

In addition, a remainder value output when row element 2 of the component in the second row and the third column is divided by 3, which is a value obtained by multiplying column number 3 of the filter matrix 300 by channel number 1, may be 2.

In this regard, since the offset of the component in the second row and the third column is 0, the ID generator 130 may generate the element ID 141 as ‘3’ obtained by adding 1 and 2 to 0 with respect to the component in the second row and the third column.

In addition, referring to FIG. 11, a remainder value output when row element 3 of the component in the fourth row and the fifth column is divided by 2, which is a value obtained by multiplying column number 2 of the output data matrix 400 by channel number 1 and stride 1, may be 1.

In addition, a remainder value output when row element 4 of the component in the fourth row and the fifth column is divided by 3, which is a value obtained by multiplying column number 3 of the filter matrix 300 by channel number 1, may be 1.

At this time, since the offset of the component in the fourth row and the fifth column is 8, the ID generator 130 may generate the element ID 141 as ‘10’ obtained by adding 1 and 1 to 8 with respect to the component in the fourth row and the fifth column.

Then, the processor 110 may update the register mapping table 121 so that first destination register addresses of components to which the same element ID is generated among the plurality of components of the input data matrix 202 correspond to the same second destination register address.

In this case, in that the element ID 141 of the plurality of components generated by the ID generator 130 has the same value with respect to the redundant components, as a result, the register mapping table 121 may be updated so that the first destination register addresses of the redundant components correspond to the same second destination register address.

In addition, the processor 110 may perform a convolutional operation by reusing a register having the same second destination register address with respect to the redundant components, based on the updated register mapping table 121 as described above.

In the above-described embodiment, the method, performed by the processor 110, of updating the register mapping table 121 when convolution of a single batch is performed has been described, but according to an embodiment of the present disclosure, even if convolution having a factor of multi-batch is performed, the processor 110 may update the register mapping table 121 so that the first destination register addresses of the redundant components correspond to the same second destination register address.

To this end, the ID generator 130 may generate an element ID and a batch ID of the plurality of components of the input data matrix 202.

In addition, the ID generator 130 may update the register mapping table 121 so that first destination register addresses of components for which the same element ID and batch ID are generated from among the plurality of components correspond to the same second destination register address.

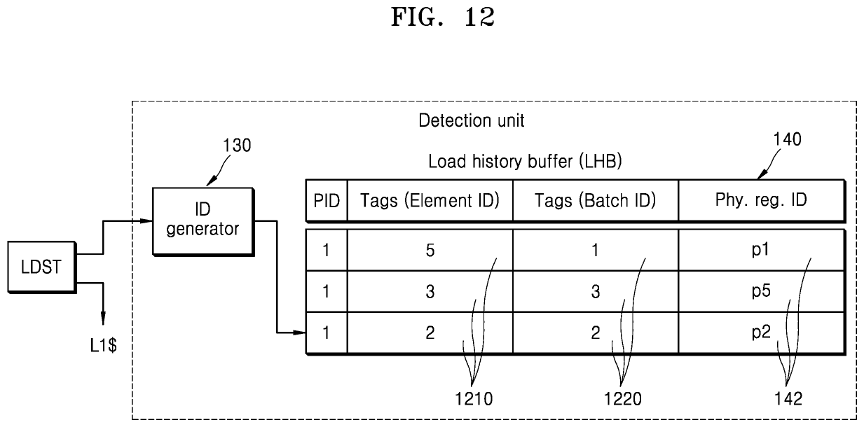

FIG. 12 is a diagram illustrating configurations of the ID generator 130 and the load history buffer 140 according to another embodiment.

Referring to FIG. 12, the ID generator 130 may generate an element ID 1210 and a batch ID 1220 of a component of an input data matrix required for a current matrix operation. In addition, the second destination register address 142 corresponding to the generated element ID 1210 and the batch ID 1220 may be recorded in the load history buffer 140.

Then, the processor 110 may identify whether the element ID 1210 and the batch ID 1220 of the component of the input data matrix required for the current operation and the second destination register address 501 corresponding thereto are recorded in the load history buffer 140.

When the element ID 1210 and the batch ID 1220 of the component of the input data matrix required for the current operation and the second destination register address 142 corresponding thereto are recorded in the load history buffer 140, the processor 110 may update the register mapping table 121 so that the second destination register address 142 corresponds to the first destination register address 501 of the corresponding component.

Accordingly, the processor 110 may reuse data stored in the register 150 having the second destination register address 142 recorded in the load history buffer 140 without accessing the memory 120 in order to load data of the component of the input data matrix required for the current matrix operation

On the other hand, when the element ID 1210 and the batch ID 1220 of the component of the input data matrix required for the current operation and the second destination register address 142 corresponding thereto are not recorded in the load history buffer 140, the processor 110 may access the memory 120 and fetch the data of the component of the first destination register address 501 from a memory layer.

Then, the processor 110 may record the corresponding element ID 1210 and the batch ID 1220 and the second destination register address 142 of the register 150, to which the corresponding data is fetched, in the load history buffer 140, and update the register mapping table 121 so that the recorded second destination register address 142 corresponds to the first destination register address 501 of the corresponding component.

To this end, the ID generator 130 may generate the element ID 1210 and the batch ID 1220 of a plurality of components of the input data matrix 202.

Here, a method performed by the ID generator 130 of allocating an array index of a plurality of components of the input data matrix 202, a method of calculating a row element and a column element, and a method of generating the element ID 1210 are the same as described above with reference to FIGS. 6 to 10, and thus descriptions thereof are omitted.

The ID generator 130 may generate the batch ID 1220 of a plurality of components of the data matrix 202, based on an array index of the plurality of components of the data matrix 202, the number of rows and the number of columns of the filter matrix 300, and the number of rows and the number of columns of the output data matrix 400.

Specifically, the ID generator 130 may generate a quotient output when the row element of the input data matrix 202 is divided by the size (a value obtained by multiplying the number of columns of the output data matrix 400 by the number of rows of the output data matrix 400) of the output data matrix 400 as the batch ID 1220.

Then, the processor 110 may update the register mapping table 121 so that the first destination register addresses 501 of components for which the same element ID is generated among the plurality of components of the input data matrix 202 correspond to the same second destination register address 142.

In this case, in that the element ID 1210 and the batch ID 1220 of the plurality of components generated by the ID generator 130 have the same value with respect to the redundant components, as a result, the register mapping table 121 may be updated so that the first destination register addresses 501 of the redundant components correspond to the same second destination register address 142.

In addition, the processor 110 may perform a convolutional operation by reusing the register 150 having the same second destination register address 142 with respect to the redundant components based on the updated register mapping table 121 as described above.

At least one constituent element may be added or deleted according to the performance of the constituent elements described above. In addition, it will be readily understood by those of ordinary skill in the art that the mutual positions of the constituent element may be changed in correspondence to the performance or structure of the system.

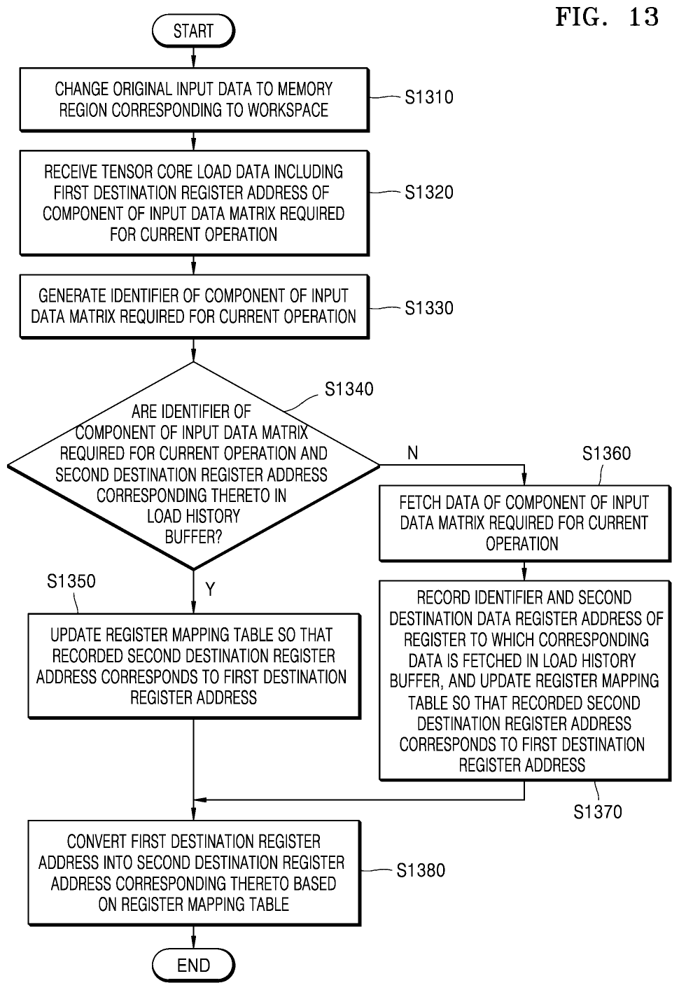

FIG. 13 is a flowchart of a convolutional operation method according to an embodiment. this is only a preferred embodiment for achieving the object of the present disclosure, and some configurations may be added or deleted as necessary.

Referring to FIG. 13, the processor 110 may change the original input data to a memory region corresponding to a workspace (1310).

In this regard, the at least one processor 110 may generate an input data matrix by changing the size of the original input data matrix, the number of components, and the order of the components to the memory region corresponding to the workspace.

Specifically, the processor 110 may generate an input data matrix by converting the original input data matrix into a workspace having the same number of rows as the number of rows of a feature data matrix and the same number of columns as the size of a filter matrix.

In addition, the processor 110 may receive tensor core load data including a first destination register address of a component of the input data matrix required for a current operation (1320).

Then, the processor 110 may generate an identifier of the component of the input data matrix required for the current operation (1330). In this case, the identifier may include an element ID. Also, when convolution having a multiple batch factor is performed, the identifier may further include a batch ID.

To this end, the processor 110 may generate a patch ID of a plurality of components of the input data matrix based on an array index of components of the input data matrix required for the current operation, the number of rows and the number of columns of a filter matrix, and the number of columns of the output data matrix.

Then, the processor 110 may generate the element ID based on the patch ID and an offset of the component of the input data matrix required for the current operation.

In addition, the processor 110 may generate the batch ID based on the array index of the component of the input data matrix required for the current operation, the number of rows and the number of columns of the filter matrix, and the number of rows and the number of columns of the output data matrix.

Then, the processor 110 may identify whether the generated identifier and a second destination register address corresponding thereto are recorded in a load history buffer (1340).

Then, when the processor 110 identifies that the generated identifier and the second destination register address corresponding thereto are recorded in the load history buffer (S1340—Y), the processor 110 may update the register mapping table 121 so that the recorded second destination register address corresponds to a first destination register address of the component of the input data matrix required for the current operation (1350).

On the other hand, when the processor 110 identifies that the generated identifier and the second destination register address corresponding thereto are not recorded in the load history buffer (S1340—N), the processor 110 may access the memory 120 and fetch data of the component of the input data matrix required for the current operation from a memory region (1360).

Then, the processor 110 may record the generated identifier and the second destination register address of the register to which the corresponding data is fetched in the load history buffer, and update the register mapping table 121 so that the recorded second destination register address corresponds to the first destination register address of the component of the input data matrix required for the current operation (1370). Then, the processor 110 may convert the first destination register address into a second destination register address corresponding thereto based on the register mapping table 121 (1380).

Accordingly, when the processor 110 performs an operation in which data of a specific first destination register component among the plurality of components of the input data matrix is used, the processor 110 may perform the operation by obtaining the corresponding data from the register 150 having the second destination register address converted from the corresponding first destination register address.

In order to verify the performance of the convolutional operation method according to an embodiment of the present disclosure, research has been conducted using GPGPU-sim together with a tensor core model. At this time, the GPGPU-sim configured with NVIDIA Titan V was used.

The research has been conducted through an operation using three representative deep neural network (DNN). Specifically, the research has been conducted through the operation using ResNet, GAN, and YOLO implemented based on the cudaTensorCoreGemm kernel of NVIDIA CUDA SDK 9.1.

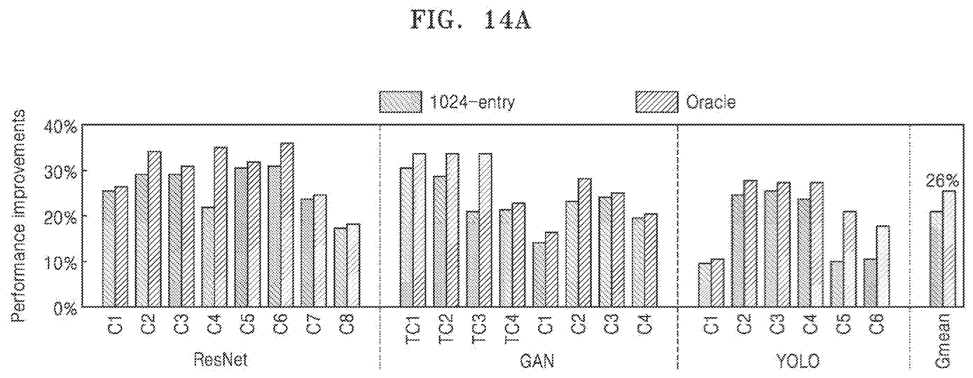

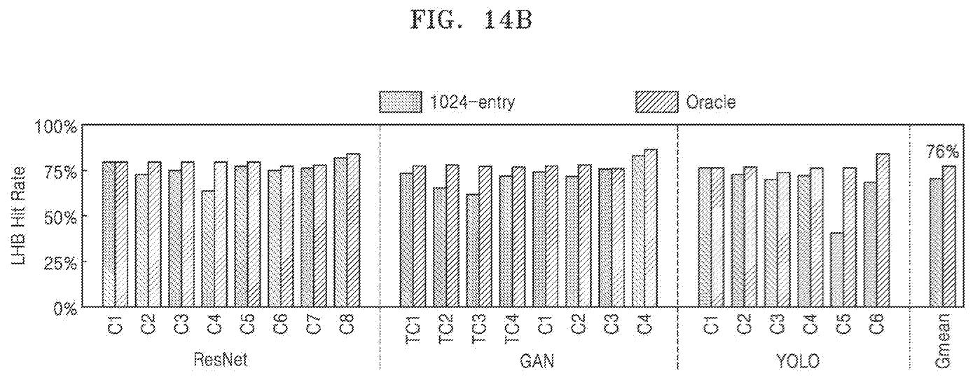

FIGS. 14A and 14B are graphs showing the effect of a convolutional operation method of the present disclosure.

Referring to FIG. 14A, it may be confirmed that the convolutional operation method according to an embodiment of the present disclosure in the Oracle state has the effect of increasing the speed by 26% compared to the conventional method.

The Oracle state may be a state in which the size of the load history buffer 140 is assumed to be infinite. However, in reality, research has been conducted on an option in which the size of the load history buffer 140 is 1024-entry. On average, the load history buffer 140 of 1024-entry showed a performance improvement of 22.1% which is about ⅘ of the Oracle state case.

Also, referring to FIG. 14B, it may be confirmed that the convolutional operation method according to the embodiment of the present disclosure in the Oracle state may reduce load of redundant tensor core by up to 76% compared to the conventional method.

At this time, in about ¾ of the total memory load, a register address was changed.

As such, in the research into the convolutional operation method of the present disclosure, it was confirmed that the operation speed increase effect of 26% and the energy saving effect of 34% were achieved by actively removing the tensor core load.

The embodiments have been described with reference to the accompanying drawings as described above. Those of ordinary skill in the art to which the present disclosure pertains will understand that the present disclosure may be practiced in other forms than the embodiments without changing the technical spirit or essential features of the present disclosure. The embodiments are illustrative and should not be construed as limiting.

According to one aspect of the present disclosure, the operation having a faster operation sped and a better energy efficiency than a general convolutional operation may be performed by converting the original input data matrix into a workspace, allocating a common destination register to redundant components redundant with each other with respect to each component of the converted input data matrix, and reusing data of the input data matrix stored in the common destination register.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. A convolutional operation method of generating a feature data matrix corresponding to an output data matrix by performing a general matrix multiplication (GEMM) operation on an input data matrix with a set filter matrix, the convolutional operation method comprising:
updating, by at least one processor, a register mapping table so that first destination register addresses of redundant components indicating data redundant with each other among a plurality of components of the input data matrix correspond to a same second destination register address; and
performing, by the at least one processor, a convolutional operation by reusing a register having the same second destination register address with respect to the redundant components, based on the register mapping table.

2. The convolutional operation method of claim 1, wherein the updating of the register mapping table comprises:
generating an identifier of the plurality of components; and
updating the register mapping table so that first destination register addresses of components for which a same identifier is generated among the plurality of components correspond to a same second destination register address.

3. The convolutional operation method of claim 2, wherein the identifier comprises an element ID,
wherein the generating of the identifier comprises:
generating a patch ID of the plurality of components based on an array index of the plurality of components, a number of rows and columns of the filter matrix, and a number of columns of the output data matrix; and
generating an element ID of the plurality of components, based on the patch ID and an offset of the plurality of components,
wherein the offset is a value determined based on the patch ID, the number of columns and a number of channels of the input data matrix, and
wherein the array index is a value indicating a location of each component when the plurality of components are arranged in a single-dimensional array.

4. The convolutional operation method of claim 3, wherein the identifier further comprises a batch ID, and
wherein the generating of the identifier further comprises generating the batch ID of the plurality of components based on the array index of the plurality of components, the number of rows and the number of columns of the filter matrix, and a number of rows and the number of columns of the output data matrix.

5. The convolutional operation method of claim 3,
wherein the generating of the patch ID comprises
calculating a first patch element and a second patch element of the plurality of components; and
generating the patch ID by adding the second patch element to a value obtained by multiplying the first patch element by a stride of the filter matrix,
wherein the first patch element is a quotient output when a row element of the plurality of components is divided by the number of columns of the output data matrix,
wherein the second patch element is a quotient output when a column element of the plurality of components is divided by the number of columns of the filter matrix,
wherein the row element is a quotient output when the array index is divided by a size of the filter matrix, and
wherein the column element is a remainder output when the array index is divided by the size of the filter matrix.

6. The convolutional operation method of claim 5,
wherein the generating of the element ID comprises generating the element ID by adding a remainder value output when the row element is divided by a value obtained by multiplying the number of columns of the output data matrix by the number of channels and the stride, and a remainder value output when the column element is divided by a value obtained by multiplying the number of columns of the filter matrix by the number of channels, to the offset, and
wherein the offset of the input data matrix is a value obtained by multiplying the patch ID by the number of columns and the number of channels of the input data matrix.

7. The convolutional operation method of claim 1, further comprising: generating, by the at least one processor, the input data matrix by changing a size of an original input data matrix and a number and an order of a plurality of components into a memory region corresponding to a workspace,
wherein the input data matrix is a matrix in which the plurality of components of the original input data matrix are recombined and arranged with a rule so that the original input data matrix outputs the feature data matrix through the filter matrix and the GEMM operation.

8. The convolutional operation method of claim 7, wherein the generating of the input data matrix comprises generating the input data matrix by converting the original input data matrix into the workspace having a same number of rows as a number of rows of the feature data matrix and a same number of columns as a size of the filter matrix.

9. The convolutional operation method of claim 1,
wherein the updating of the register mapping table comprises:
receiving tensor core load data;
identifying whether an identifier of a component having a first destination register address and a second destination register address included in the tensor core load data are recorded in a load history buffer;
when the identifier and the second destination register address are not recorded in the load history buffer, accessing a memory and fetching data of the component from a memory layer, recording a second destination register address of a register in which the identifier and the fetched data are stored in the load history buffer, and updating the register mapping table so that the second destination register address recorded in the load history buffer corresponds to the first destination register address; and
when the identifier and the second destination register address are recorded in the load history buffer, updating the register mapping table so that the second destination register address recorded in the load history buffer corresponds to the first destination register address without accessing the memory.

10. A computer program stored in a computer-readable recording medium to execute the convolutional operation method according to claim 1.

11. A convolutional operation device comprising:
a memory storing a register mapping table; and
a processor configured to perform a convolutional operation for generating a feature data matrix corresponding to an output data matrix by performing a general matrix multiplication (GEMM) operation on an input data matrix with a set filter matrix, update a register mapping table so that first destination register addresses of redundant components indicating data redundant with each other among a plurality of components of the input data matrix correspond to a same second destination register address; and perform the convolutional operation by reusing a register having the same second destination register address with respect to the redundant components, based on the register mapping table.

12. The convolutional operation device of claim 11,
wherein the processor is further configured to generate an identifier of the plurality of components; and update the register mapping table so that first destination register addresses of components for which a same identifier is generated among the plurality of components correspond to a same second destination register address.

13. The convolutional operation device of claim 12, wherein the identifier comprises an element ID,
wherein the processor is further configured to generate a patch ID of the plurality of components based on an array index of the plurality of components, a number of rows and columns of the filter matrix, and a number of columns of the output data matrix; and generate an element ID of the plurality of components based on the patch ID and an offset of the plurality of components,
wherein the offset is a value determined based on the patch ID, the number of columns and a number of channels of the input data matrix, and
wherein the array index is a value indicating a location of each component when the plurality of components are arranged in a single-dimensional array.

14. The convolutional operation device of claim 13, wherein the identifier further comprises a batch ID, and
wherein the processor is further configured to generate the batch ID of the plurality of components based on the array index of the plurality of components, the number of rows and the number of columns of the filter matrix, and a number of rows and the number of columns of the output data matrix.

15. The convolutional operation device of claim 13,
wherein the processor is further configured to calculate a first patch element and a second patch element of the plurality of components and generate the patch ID by adding the second patch element to a value obtained by multiplying the first patch element by a stride of the filter matrix,
wherein the first patch element is a quotient output when a row element of the plurality of components is divided by the number of columns of the output data matrix,
wherein the second patch element is a quotient output when a column element of the plurality of components is divided by the number of columns of the filter matrix,
wherein the row element is a quotient output when the array index is divided by a size of the filter matrix, and
wherein the column element is a remainder output when the array index is divided by the size of the filter matrix.

16. The convolutional operation device of claim 15,
wherein the processor is further configured to generate the element ID by adding a remainder value output when the row element is divided by a value obtained by multiplying the number of columns of the output data matrix by the number of channels and the stride, and a remainder value output when the column element is divided by a value obtained by multiplying the number of columns of the filter matrix by the number of channels, to the offset, and
wherein the offset of the input data matrix is a value obtained by multiplying the patch ID by the number of columns and the number of channels of the input data matrix.

17. The convolutional operation device of claim 11,
wherein the processor is further configured to generate the input data matrix by changing a size of an original input data matrix and a number and an order of a plurality of components into a memory region corresponding to a workspace,
wherein the input data matrix is a matrix in which the plurality of components of the original input data matrix are recombined and arranged with a rule so that the original input data matrix outputs the feature data matrix through the filter matrix and the GEMM operation.

18. The convolutional operation device of claim 17, wherein the processor is further configured to generate the input data matrix by converting the original input data matrix into the workspace having a same number of rows as a number of rows of the feature data matrix and a same number of columns as a size of the filter matrix.

19. The convolutional operation device of claim 11,
wherein the processor is further configured to receive tensor core load data, identify whether an identifier of a component having a first destination register address and a second destination register address included in the tensor core load data are recorded in a load history buffer; when the identifier and the second destination register address are not recorded in the load history buffer, fetch data of the component, record a second destination register address of a register in which the identifier and the fetched data are stored in the load history buffer, and update the register mapping table so that the second destination register address recorded in the load history buffer corresponds to the first destination register address; and when the identifier and the second destination register address are recorded in the load history buffer, update the register mapping table so that the second destination register address recorded in the load history buffer corresponds to the first destination register address.
